(19) United States
(12) Patent Application Publication
(10) Pub. No.: US 2010/0242089 A1
(43) Pub. Date: Sep. 23, 2010

(54) PRIVACY CONTROL BETWEEN MOBILE AND HOME NETWORK BASE STATION

(75) Inventor: Hao BI, Lake Zurich, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 12/407,912

(22) Filed: Mar. 20, 2009

(51) Int. Cl. H04L 29/06; H04W 12/06

(52) U.S. Cl. 726/3; 455/434

(57) ABSTRACT

A method, a mobile system, and a home network base station are disclosed. A network operator server 106 may identify a mobile system 104 accessing a home network 108 associated with a closed subscriber group. The network operator server 106 may determine a trust level associated with the closed subscriber group and the mobile system 104. The network operator server 106 may provide an access protocol for the mobile system 104 to access the home network 108 based on the trust level.

### FIELD OF THE INVENTION

The present invention relates to a method and system for accessing a home network. The present invention further relates to storing a trust level to determine the amount of data transmitted and the degree of access granted.

### INTRODUCTION

A mobile system may access a universal terrestrial radio access network (UTRAN) and an evolved UTRAN (E-UTRAN) cellular network through base stations installed at domestic home or belonging to business and commercial enterprises, called Home NodeB (HNB) in UTRAN and Home eNodeB (HeNB) in E-UTRAN. The HNB or the HeNB may be part of an at least partially wireless local area network (LAN) referred to as a home network.

The access to a HNB and a HeNB may be controlled through a closed subscriber group (CSG) membership. Each HNB and HeNB may be associated with a particular CSG, such that a mobile user with a valid membership to that CSG may gain access. An allowed CSG identifier (ID) list may contain the information of which CSG the mobile user has access or a subscription. The CSG ID list may be used by a mobile or a network to control access to the HeNB.

### SUMMARY OF THE INVENTION

A method, a mobile system, and a home network base station are disclosed. A network operator server may identify a mobile system accessing a home network associated with a closed subscriber group. The network operator server may determine a trust level associated with the closed subscriber group and the mobile system. The network operator server may provide an access protocol for the mobile system to access the home network based on the trust level.

### BRIEF DESCRIPTION OF THE DRAWINGS

Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one embodiment of a communication system.

FIG. 2 illustrates a possible configuration of a computing system to act as a base transceiver station.

FIG. 3 illustrates in a block diagram one embodiment of a mobile system or electronic device to create a radio connection.

FIG. 4 illustrates, in a block diagram, one embodiment of an architectural layout of a home network base station.

FIG. 5 illustrates, in a block diagram, one embodiment of a home network interaction.

FIGS. 6a-c illustrate, in block diagrams, multiple embodiments of a closed subscriber group identity list.

FIG. 7 illustrates, in a flowchart, one embodiment of a method for controlling a home network access using a network operator server.

FIG. 8 illustrates, in a flowchart, one embodiment of a method for initiating a home network access using a network operator server.

FIG. 9 illustrates, in a flowchart, one embodiment of a method for receiving a home network access using a network operator.

FIG. 10 illustrates, in a flowchart, one embodiment of a method for initiating a home network access without a network operator server.

FIG. 11 illustrates, in a flowchart, one embodiment of a method for receiving a home network access without a network operator server.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, a mobile system, and a home network base station are disclosed. A network operator server may identify a mobile system accessing a home network associated with a closed subscriber group. The network operator server may determine a trust level associated with the closed subscriber group for that mobile system. The network operator server may provide an access protocol for the mobile system to access the home network based on the trust level.

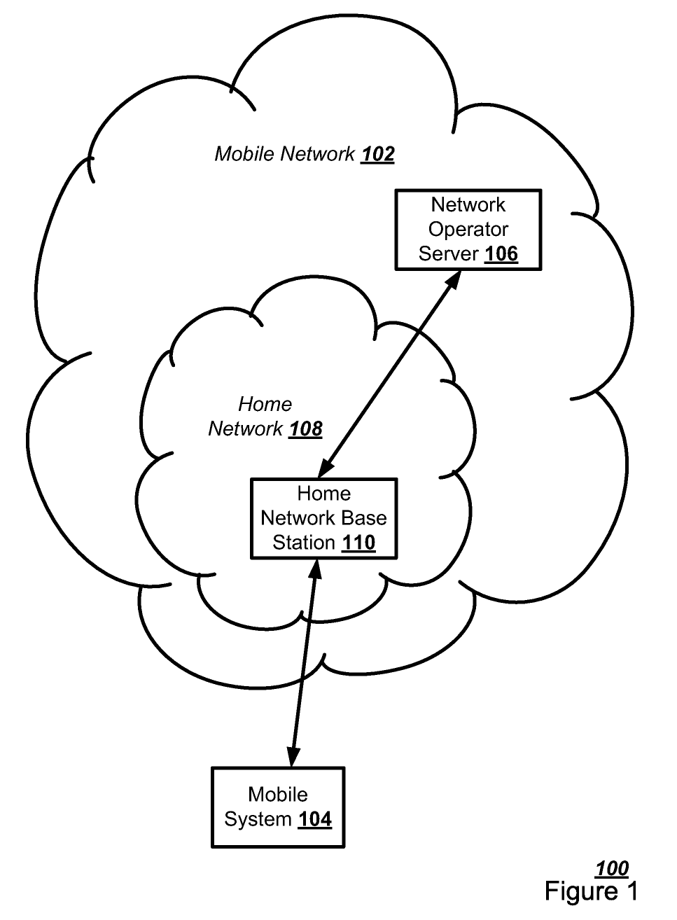

FIG. 1 illustrates one embodiment of a communication system 100. The communication system 100 may include a mobile network 102 that may be accessed by at least one mobile device 104, such as an electronic device or mobile system. Various communication devices may exchange data or information through the mobile network 102. The mobile network 102 may be a WiMAX network, a universal terrestrial radio access network (UTRAN) cellular network, an evolved UTRAN (E-UTRAN) cellular network, or other types of telecommunication network. A server or a series of servers controlled by a network operator, referred to herein as a network operator server 106, may administer the network. The network operator server 106 may maintain a set of data to facilitate access of the mobile network 102 by a mobile system 104.

A home, office, or other localized setting may maintain a home network 108. The home network 108 may be an at least partially wireless local area network (LAN) connected to the mobile network 102. The home network 108 may be connected to the mobile network 102 via one or more home network base station 110, such as a home NodeB (HNB) or a home evolved NodeB (HeNB). The mobile system 104 may use the home network base station 110 to access either the mobile network 102 or the home network 108. The home network 108 may allow a mobile system 102 access if the mobile system 102 is a part of a closed subscriber group (CSG) associated with the home network 108. The mobile system 104 may store a list of CSG identifiers (ID), or CSG ID list, detailing which home networks 108 the mobile system 104 may access. The network operator server 106 may store the CSG ID list to administer access to the various home networks.

If the home network base station 110 is a closed base station, a mobile system 104 may connect with the home network base station 110 if the mobile system 104 is a member of the associated CSG. If the home network base station 110 is a hybrid base station or open base station, a mobile system 104 may use the home network base station 110 to connect with the mobile network 102 even if the mobile system 104 is not a member of the associated CSG.

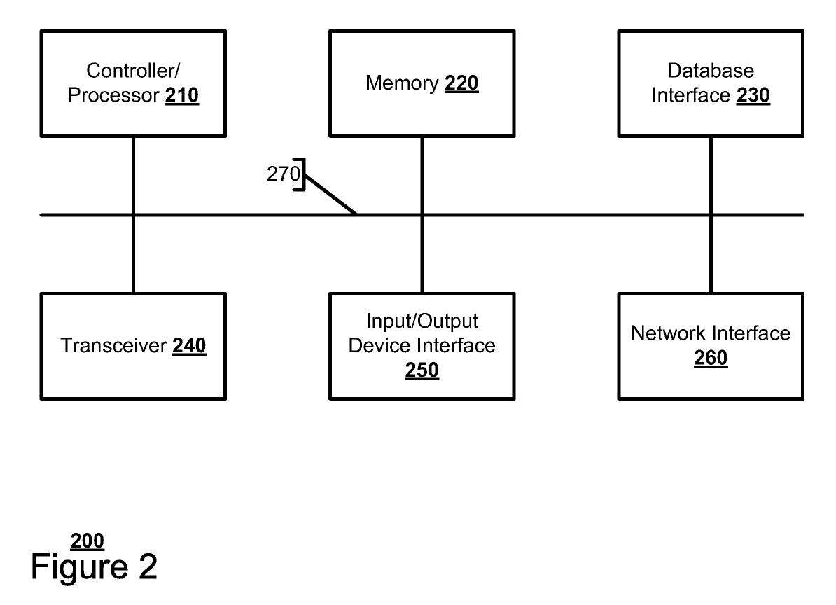

FIG. 2 illustrates a possible configuration of a computing system 200 to act as a network operator server 106 or a home network base station 110. The computing system 200 may include a controller/processor 210, a memory 220, a database interface 230, a transceiver 240, input/output (I/O) device interface 250, and a network interface 260, connected through bus 270. The network server 200 may implement any operating system. Client and server software may be written in any programming language, such as C, C++, Java or Visual Basic, for example. The server software may run on an application framework, such as, for example, a Java® server or .NET® framework

The controller/processor 210 may be any programmed processor known to one of skill in the art. However, the decision support method may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein may be used to implement the decision support system functions of this invention.

The memory 220 may include volatile and nonvolatile data storage, including one or more electrical, magnetic or optical memories such as a random access memory (RAM), cache, hard drive, or other memory device. The memory may have a cache to speed access to specific data. The memory 220 may also be connected to a compact disc-read only memory (CD-ROM, digital video disc-read only memory (DVD-ROM), DVD read write input, tape drive, or other removable memory device that allows media content to be directly uploaded into the system.

Data may be stored in the memory or in a separate database. The database interface 230 may be used by the controller/processor 210 to access the database. The database may contain a subscriber information set for each mobile system that may access the mobile network 102 or a home network 108.

The transceiver 240 may create a connection with the mobile device 104. The transceiver 240 may be incorporated into the base station 200 or may be a separate device.

The I/O device interface 250 may be connected to one or more input devices that may include a keyboard, mouse, pen-operated touch screen or monitor, voice-recognition device, or any other device that accepts input. The I/O device interface 250 may also be connected to one or more output devices, such as a monitor, printer, disk drive, speakers, or any other device provided to output data. The I/O device interface 250 may receive a data task or connection criteria from a network administrator.

The network connection interface 260 may be connected to a communication device, modem, network interface card, a transceiver, or any other device capable of transmitting and receiving signals from the network. The network connection interface 260 may be used to connect a client device to a network. The network connection interface 260 may be used to connect the teleconference device to the network connecting the user to other users in the teleconference. The components of the network server 200 may be connected via an electrical bus 270, for example, or linked wirelessly.

Client software and databases may be accessed by the controller/processor 210 from memory 220, and may include, for example, database applications, word processing applications, as well as components that embody the decision support functionality of the present invention. The network server 200 may implement any operating system. Client and server software may be written in any programming language. Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

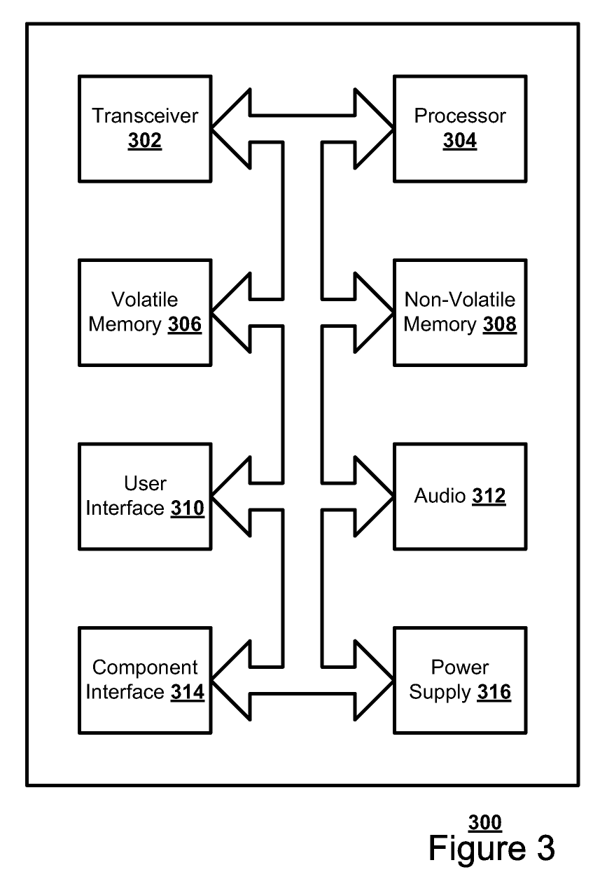

FIG. 3 illustrates one embodiment of a mobile device 300, capable of acting as a mobile system or electronic device. For some embodiments of the present invention, the mobile device 300 may also support one or more applications for performing various communications with a network. The mobile device 300 may be a handheld device, such as, a mobile phone, a laptop, or a personal digital assistant PDA). For some embodiments of the present invention, the user device 300 may be WiFi® capable device, which may be used to access the network mobile for data or by voice using VOIP.

The mobile device 300 may include a transceiver 302, which is capable of sending and receiving data over the mobile network 102. The mobile device 300 may include a processor 304 that executes stored programs. The mobile device 300 may also include a volatile memory 306 and a non-volatile memory 308 which may provide data storages for the processor 304. The mobile device 300 may include a user input interface 310 that may comprise elements such as a keypad, display, touch screen, and the like. The mobile device 300 may also include a user output device that may comprise a display screen and an audio interface 312 that may comprise elements such as a microphone, earphone, and speaker. The mobile device 300 also may include a component interface 314 to which additional elements may be attached, for example, a universal serial bus (USB) interface. Finally, the mobile device 300 may include a power supply 316.

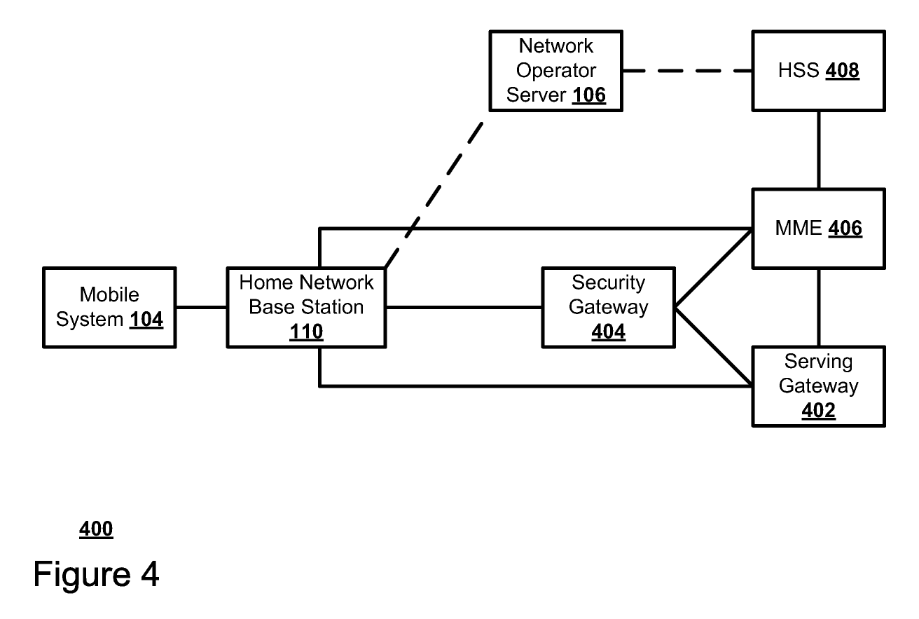

FIG. 4 illustrates, in a block diagram, one embodiment of an architectural layout 400 of a home network base station 110. A mobile system 104 may access a network operator server 106, or CSG server 106, via the home network base station 110. The home network base station 110 may use a serving gateway 402 to create a data communications link between the mobile system 104 and the mobile network 102 once a connection has been established. The home network base station 110 may use a security gateway 404 to establish a secure connection with the mobile network 102. The CSG server 106 may use these connections to establish the level of trust between the mobile system 104 and the home network 108.

The network operator server 106 may store and configure a CSG ID list for each mobile system 106. A mobile user may trigger the updating of CSG ID list using manual selection. A user may request the mobile system 104 to perform a scan of nearby home network base stations 110. The mobile system 104 may display the CSG identities and names of the found home network base stations 110, indicating which CSG IDs are on the CSG ID list. When the user selects a home network base station 110 with a CSG ID not on the CSG ID list, the mobile system 104 may try to access the network through an attach, tracking area update (TAU), or service request procedure. If the home network base station 110 grants access, the mobile system 104 may add the associated CSG ID to the CSG ID list.

To support handover, the mobile network 102 may determine if the mobile system 104 may access a neighboring home network base station 110. If the CSG ID associated with the neighboring home network base station is on the CSG ID list for the mobile system 104, the potential handover target may allow access. If not, the potential handover target may deny access. A mobility management entity (MME) 406 may store a copy of the CSG ID list for the mobile system 104. The MME 406 may use a handover preparation procedure to perform mobility control.

The network operator server 106 may store the CSG ID list on the serving home network base station 110 to perform the filtering on the neighboring home network base station 110 to determine the potential handover target. Storing the CSG ID list on the home network base station 110 may reduce the signaling exchange and operation load on MME 406. However, if the CSG ID list for the mobile system is transferred each time a home network base station 110 is accessed, accessing a foreign home network base station 110 as a guest user may result in the owner of the foreign home network base station 110 obtaining the subscription information of the mobile user. A user's subscription information may become accessible to a party who is not the user or a network operator.

The CSG server 106 may send a CSG ID list with an associated trust level for each CSG ID to both the mobile system 104 and the home network base station 110. The associated trust level may indicate the degree of private information sharing the mobile system 104 has for the home network 108 or the degree of private information sharing that the home network 108 has for the mobile system 104. Additionally, for a home network 108 with multiple home network base stations 110, the CSG server 106 may indicate a different set of trust levels based on which home network base station 110 the mobile system 104 is connected to.

Currently the CSG ID list may contain the ID of CSG whose home network 108 the mobile system 104 may access. The mobile network 102 may provision or configure an entry to indicate whether a home network 108 or a home network base station 110 may be trusted with the CSG ID list of the mobile system 104. If so, then the home network base station 110 may get a copy of the CSG ID list during connection setup or handover procedures. With the CSG ID list, the home network base station 110 may choose those neighboring home networks 108 on the CSG ID as potential handover targets. A user may assign a home network trust level to the selected home network 108 or even a base station trust level to the home network base station 110 during the manual selection procedure. If the mobile system 104 is granted access to the home network 108, the network operator server 106 may send a subscriber information set, such as the allowed CSG ID list, to the home network 108 based on the home network trust level the user set.

A network operator server 106 may provision or configure a mobile trust level, representing the allowed access level to the home network 108, or a base mobile trust level, representing the allowed access level to the home network base station 110, for the mobile system 104 in the subscription information. A home network owner may contact a CSG server 106 to modify the membership of a CSG. The home network owner may provide CSG server 106 with a mobile ID, such as a phone number and a service provider, and the trust level assigned to this user. The CSG server 106 may contact the home subscriber service (HSS) 408 of an impacted user to update the user's subscription information, such as the CSG ID list. The HSS 408 may then pass the update to the MME 406, allowing the home network owner to assign users different levels of access to the home network 408. For example, the owner may give his or her own mobile system 104 full access to all devices on the home network 108, but give a guest limited or no access.

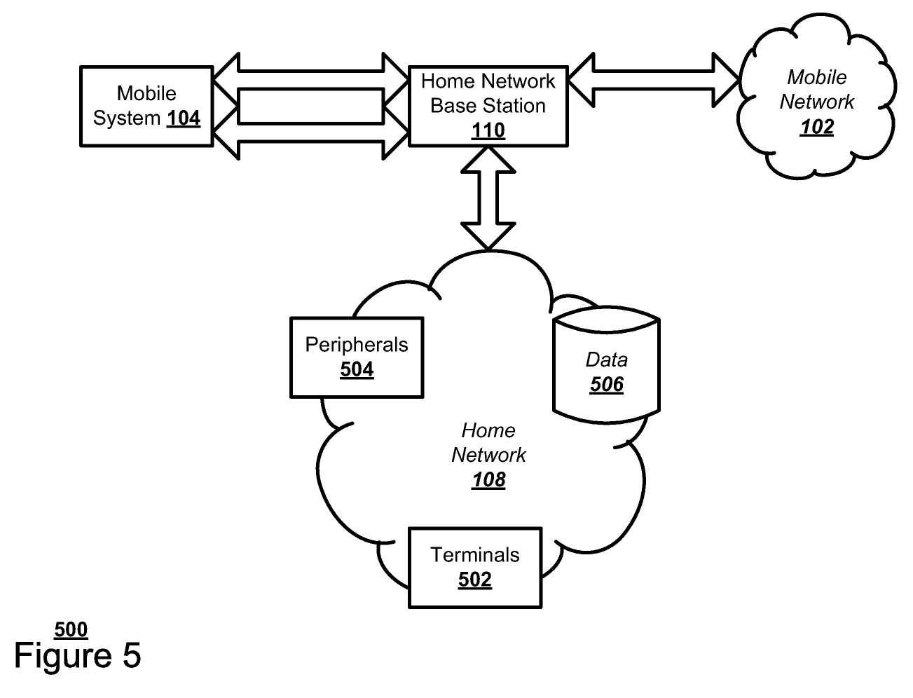

FIG. 5 illustrates, in a block diagram, one embodiment of a home network interaction 500. A mobile system 104 may access a mobile network 102, or core network 102, via the home network base station 110. Additionally, if the home network 108 is on the CSG ID list for the mobile system 104, the mobile system 104 may access the home network 108. Local internet protocol (IP) access may provide a directly connected, IP capable mobile access to other IP capable devices in the home network 108. A home network owner may have control over access to the home network 110. The home network base station 110 may provide varying degrees of access to a portion of the home network 108 based on the mobile trust level provided by the network operator server 106. For example, the home network owner may allow a guest user to use the home network 108 to make a phone call to mobile operator's network, but may not allow the guest access to devices on the home network 108 for privacy concern.

For example, a mobile system 104 with a low mobile trust level may be limited to sending and receiving communications to user terminals 502 on the home network 108 or limited to contact with the mobile network 102. A mobile system 104 with an intermediate mobile trust level may user peripheral devices 504 connected to the home network 108, such as printers, audio players, video displays, and other peripheral devices. A mobile system 104 with a high mobile trust level may access data 506 stored in the home network 108.

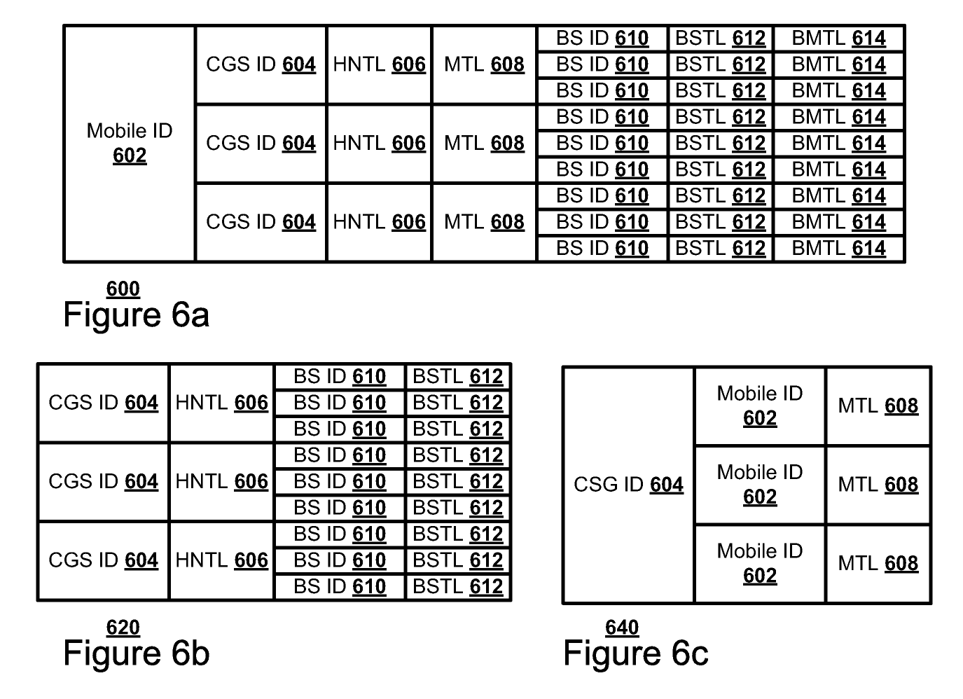

FIGS. 6a-c illustrate, in block diagrams, different embodiments of a CSG ID list. The network operator server 106 may store a master copy of the CSG ID list 600, as shown in FIG. 6a. The master CSG ID list 600 may be indexed by a mobile ID 602. The master CSG ID list 600 may include the CSG ID 604 of each CSG to which the mobile system 104 belongs. The CSG ID 604 may be associated with a trust level. Based on that trust level, the network operator server 106 may provide an access protocol for the mobile system 104 to access a home network 108. The access protocol may instruct the MME 406 to what degree private subscriber information may be sent to the home network 108. Further, the access protocol may instruct the home network 108 what degree of access may be granted to the mobile system 104.

The CSG ID 604 may be associated with a home network trust level (HNTL) value 606, representing the degree of private data sharing granted to the home network 108. The CSG ID 604 may be associated with a mobile trust level (MTL) value 608, representing the degree of access the home network 108 may grant to the mobile system 104.

Individual home base network stations 110 within a CSG may have a different degree of trust with mobile system 104 than the others of the CSG. The CSG ID list 600 may manage this data by associating a set of one or more fields representing a base station BS) ID 610 for a home network base station 110 with a CSG ID 604. The CSG ID list 600 may have a BS ID 610 for each home network base station 110 associated with that CSG or for those home network base stations 110 that have a trust level that differ from the standard trust level for that CSG. The BS ID 610 may be associated with a base station trust level (BSTL) value 612, representing the degree of private data sharing the mobile system 104 may have with the home network base station 110. The BS ID 610 may be associated with a base mobile trust level (BMTL) value 614, representing the degree of access the home network base station 110 may grant to the mobile system 104.

The mobile system 104 may store a mobile CSG ID list 620, as shown in FIG. 6b. The mobile CSG ID list 620 may be indexed by the CSG ID 604, with an associated HNTL 606. The mobile CSG ID list 620 may have a BSTL 612 for a specific BS ID 610 within the CSG. The home network base station 110 may store a home network CSG ID list 640, as shown in FIG. 6c. The home network CSG ID list 640 may be associated with a CSG ID 604 and indexed by the mobile ID 602, with either an associated MTL 608, or, if present, a BMTL 614.

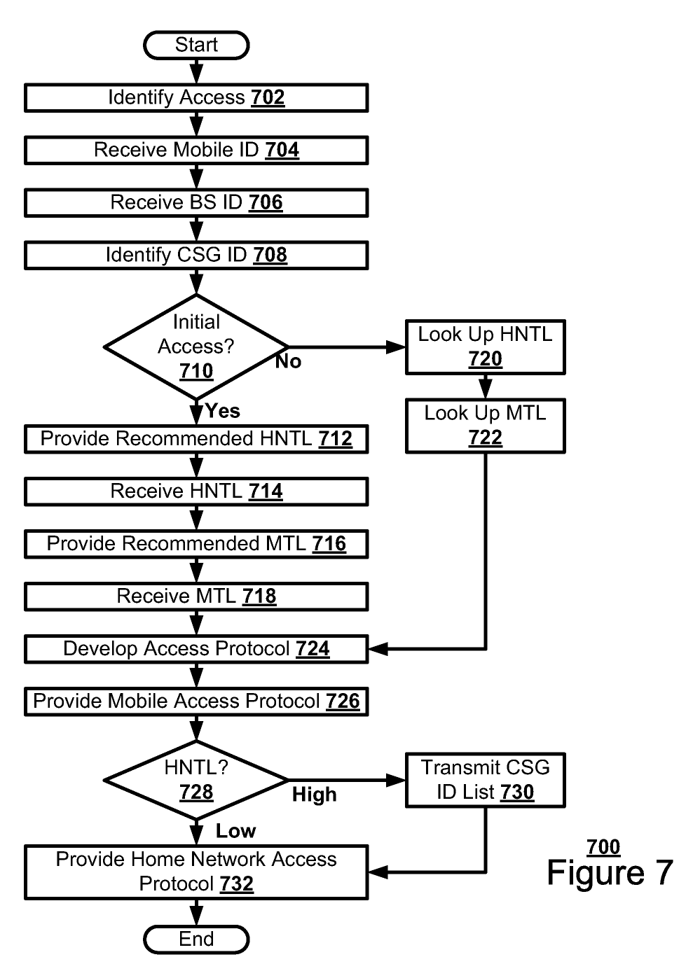

FIG. 7 illustrates, in a flowchart, one embodiment of a method 700 for controlling a home network access using a network operator server 106. The MME 406 may identify an access attempt of a home network 108 of mobile system 104 (Block 702). The network operator 106 may send the MME 406 a copy of the master CSG ID list 600. The MME 406 may receive a mobile ID 602 from the mobile system 104 to look up the master CSG ID list 600 (Block 704). The MME 406 may receive the BS ID 610 from the home network base station 110 (Block 706). The MME 406 may identify the CSG ID 604 based on the BS ID (Block 708). If the mobile system 104 has manually selected the home network 108, indicating an initial access by the mobile system 104 (Block 710), the MME 406 may provide a recommended HNTL 606 to the mobile system 104 based upon the HNTL 606 for other mobile systems 104 in that CSG (Block 712). The MME 406 may receive a user selected HNTL 606 from the mobile system 104 (Block 714). If no HNTL 606 is received from the mobile system 106, the MME 406 may use a default HNTL 606. The MME 406 may provide a recommended MTL 608 to the home network 108 based upon the MTL 608 for other mobile systems 104 in that CSG (Block 716). The MME 406 may receive a home network owner selected MTL 608 from the home network 108 (Block 718). The home network owner may manually select an MTL 608 or may automatically select an MTL 608 based on a set of criteria, either default or established by the home network owner. The user or the home network owner may specifically associate the trust levels with a specific home network base station 110 rather than the entire home network 108 or CSG. If no MTL 608 is received from the home network owner, the MME 406 may use a default MTL 608. If the mobile system 104 has previously accessed the home network 108 (Block 710), the MME 406 may look up the HNTL 606 on the master CSG ID list 600 based on the mobile ID 602 and the CSG ID 604 (Block 720). The MME 406 may look up the MTL 608 on the CSG ID list 600 based on the mobile ID 602 and the CSG ID 604 (Block 722).

The network operator server 106 may develop an access protocol based on the HNTL 606 and the MTL 608 (Block 724). The access protocol may be a general access protocol applicable to both the mobile system 104 and the home network 108. Alternately, the network operator server 106 may develop a mobile access protocol for the mobile system 104 and a home network access protocol for the home network 108. The network operator server 106 may provide the mobile access protocol to the mobile system 104 (Block 726). As part of the mobile access protocol, the MME 406 may send the HNTL 606 to the mobile system 104. If the HNTL 606 is high (Block 728), the MME 406 may send a CSG ID list 600 to the home network base station 110 (Block 730). If the HNTL 606 is low (Block 728), the MME 406 may opt to not send the master CSG ID list 600 to the home network base station 110. The network operator server 106 may provide the home network access protocol to the home network 108 (Block 732).

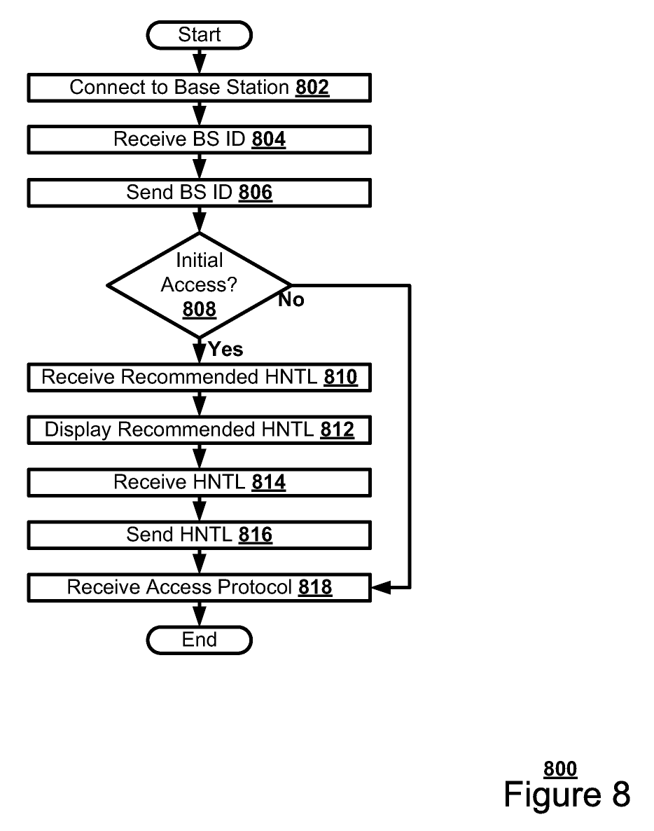

FIG. 8 illustrates, in a flowchart, one embodiment of a method 800 for initiating a home network access using a network operator server 106. The mobile system 104 may connect to a home network base station 110 of a home network 108 (Block 802). The mobile system 104 may receive the BS ID 610 from the home network base station 110 Block 804). The mobile system 104 may send the BS ID 610 to the MME 406 Block 806). If the mobile system 104 has manually selected the home network 108, indicating an initial access by the mobile system 104 (Block 808), the mobile system 104 may receive a recommended HNTL 606 from the MME 406 based upon the HNTL 606 for other mobile systems 104 in that CSG Block 810). The mobile system 104 may display the recommended HNTL 606 to the user (Block 812). The mobile system 104 may receive a user selected HNTL 606 via the user interface 310 Block 814). The mobile system 104 may send the HNTL 606 to the MME 406 to update the master CSG ID list 600(Block 816). The user may specifically associate a base station trust level 612 with a specific home network base station 110 rather than the entire home network 108 or CSG. The mobile system 104 may receive an access protocol from the network operator server 106 based on a received HNTL 606 or a stored HNTL 606 Block 818).

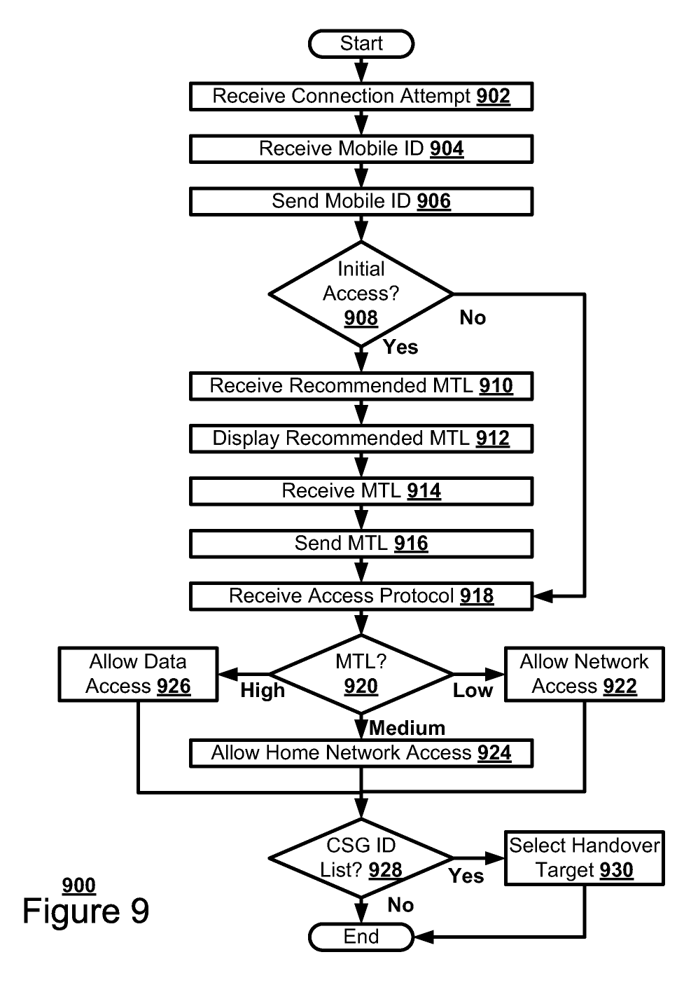

FIG. 9 illustrates, in a flowchart, one embodiment of a method 900 for receiving a home network access using a network operator server 106. The home network base station 110 may receive a connection attempt from the mobile system 104 Block 902). The home network base station 110 may receive a mobile ID 602 from the mobile system 104 Block 904). The home network base station 110 may send the mobile ID 602 to the MME 406 (Block 906). If the mobile system 104 has manually selected the home network base station 110, indicating an initial access by the mobile system 104 (Block 908), the home network base station 110 may receive a recommended MTL 608 from the MME 406 based upon the MTL 608 for other mobile systems 104 in that CSG (Block 910). The home network base station 110 may display the recommended MTL 608 to the home network owner (Block 912). The home network base station 110 may receive a manually selected MTL 608 from the home network owner via the input/output device interface 250 (Block 914). Alternately, the home network base station 110 may automatically select an MTL 608 based on a set of criteria, either default or established by the home network owner. The home network 108 may send the MTL 608 to the MME 406 (Block 916). The home network owner may specifically associate a base mobile trust level 614 with a specific home network base station 110 rather than the entire home network 108 or CSG. The home network base station 110 may receive an access protocol from the network server operator 106 based on a received MTL 608 or a stored MTL 608 (Block 918).

If the MTL is low (Block 920), the home network base station 110 may allow the mobile system 104 to access the mobile network 102 (Block 922). If the MTL is medium (Block 920), the home network base station 110 may allow the mobile system 104 to access peripherals on the home network 108 (Block 924). If the MTL is high (Block 920), the home network base station 110 may allow the mobile system 104 to access data stored in the home network 108 (Block 926). If the home network base station 110 receives a subscriber information set from the MME 406, such as a CSG ID list (Block 928), the home network 104 may select a potential handover target based on the CSG ID list (Block 930).

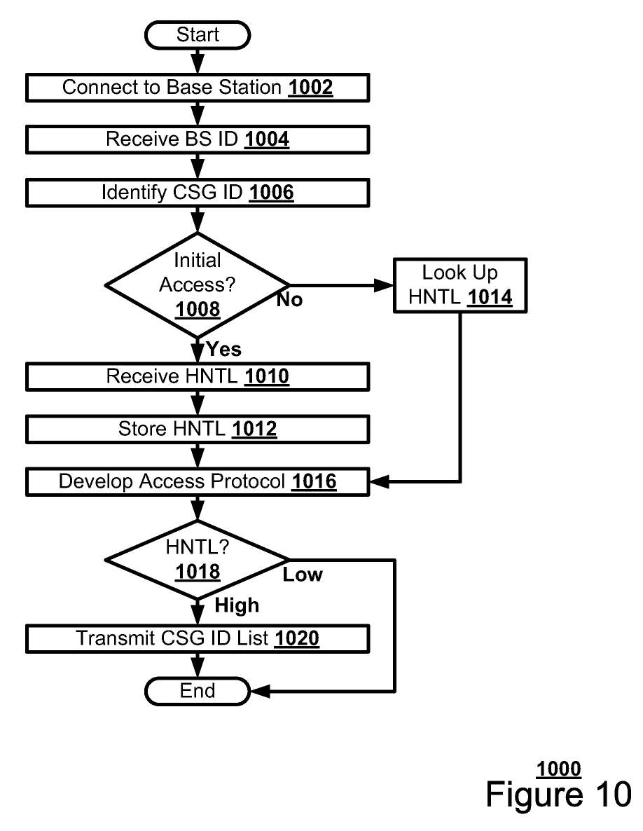

In an alternate embodiment, the mobile system 104 may access the home network base station 110 without the use of a network operator server 106 by storing a separate mobile CSG ID list 620 on the mobile system 106 and a separate home network CSG ID list 640 on the home network base station 110. FIG. 10 illustrates, in a flowchart, one embodiment of a method 1000 for initiating a home network access without a network operator server 106. The mobile system 104 may connect to a home network base station 110 of a home network 108 (Block 1002). The mobile system 104 may receive the BS ID 610 from the home network base station 110 (Block 1004). The mobile system 104 may identify the CSG ID 604 based on the BS ID 610 (Block 1006). If the mobile system 104 has manually selected the home network 108, indicating an initial access by the mobile system 104 (Block 1008), the mobile system 104 may receive a user selected HNTL 606 via the user interface 310 (Block 1010). The mobile system 104 may store the HNTL 606 in the non-volatile memory 308 (Block 1012). The mobile system 104 may use a default HNTL 606 if the user does not enter an HNTL 606. If the mobile system 104 has previously accessed the home network 108 (Block 1008), the mobile system 104 may look up the HNTL 606 on a mobile CSG ID list 620 based on the CSG ID 604 (Block 1014). The mobile system 104 may develop an access protocol based on the HNTL 606 (Block 1016). If the HNTL 606 is high (Block 1018), the mobile system 104 may transmit a CSG ID list 620 to the home network 108 (Block 1020). If the HNTL 606 is low (Block 1018), the mobile system 104 may opt to not send the CSG ID list 620.

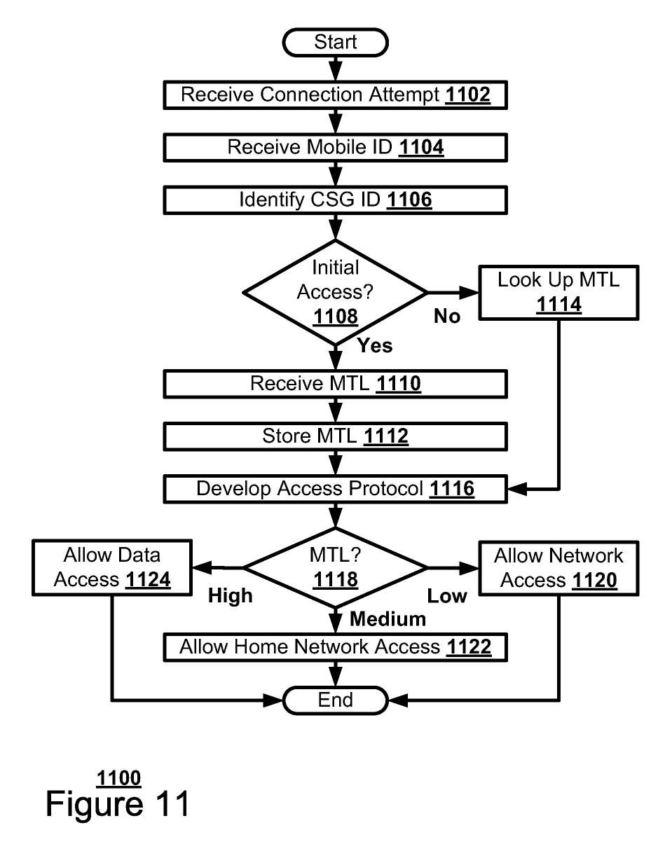

FIG. 11 illustrates, in a flowchart, one embodiment of a method 1100 for receiving a home network access without a network operator server 106. The home network base station 110 may receive a connection attempt from the mobile system 104 (Block 1102). The home network base station 110 may receive a mobile ID 602 from the mobile system 104 (Block 1104). The home network 108 may identify the CSG ID 604 based on the mobile ID 602 (Block 1106). If the mobile system 104 has manually selected the home network base station 110, indicating an initial access by the mobile system 104 (Block 1108), the home network base station 110 may receive a manually selected MTL 608 from the home network owner via the input/output device interface 250 (Block 1110). Alternately, the home network base station 110 may automatically select an MTL 608 based on a set of criteria, either default or established by the home network owner. The home network base station 110 may store the MTL 608 in the memory 220 Block 1112). If the mobile system 104 has previously accessed the home network 108 Block 1108), the home network base station 110 may look up the MTL 608 on the home network CSG ID list 640 based on the mobile ID 602 (Block 1114).

The home network base station 110 may develop an access protocol based on the MTL 608 Block 1116). If the MTL is low (Block 1118), the home network base station 110 may allow the mobile system 104 to access the mobile network 102 Block 1120). If the MTL is medium (Block 1118), the home network base station 110 may allow the mobile system 104 to access peripherals on the home network 108 (Block 1122). If the MTL is high (Block 1118), the home network base station 110 may allow the mobile system 104 to access data stored in the home network 108 (Block 1124).

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for providing access to a home network, comprising:
identifying a mobile system accessing the home network associated with a closed subscriber group;
determining a trust level associated with the closed subscriber group and the mobile system; and
providing an access protocol for the mobile system to access the home network based on the trust level.

2. The method of claim 1, wherein the home network receives a subscriber information set as part of the access protocol.

3. The method of claim 2, wherein the home network may select a potential handover target based on the subscriber information set.

4. The method of claim 1, further comprising:
storing a home network trust level associated with the closed subscriber group.

5. The method of claim 1, further comprising:
receiving a home network trust level from a user.

6. The method of claim 1, further comprising:
providing a recommended home network trust level to a user.

7. The method of claim 1, further comprising:
determining a base station trust level associated with a home network base station of the home network.

8. The method of claim 1, further comprising:
providing a mobile trust level to the home network.

9. The method of claim 1, wherein the access protocol allows access to a portion of the home network based upon a mobile trust level.

10. A mobile system for accessing to a home network, comprising:
a processor that identifies a closed subscriber group associated with the home network and determines a home network trust level associated with the closed subscriber group; and
a transceiver that accesses a home network base station of the home network using an access protocol based on the home network trust level.

11. The mobile system of claim 10, wherein the transceiver sends a subscriber information set to the home network base station as part of the access protocol.

12. The mobile system of claim 11, wherein the transceiver receives the home network trust level from a network operator server.

13. The mobile system of claim 10, further comprising:
a data storage that stores the home network trust level.

14. The mobile system of claim 10, further comprising:
a user interface that receives a home network trust level from a user.

15. The mobile system of claim 10, wherein the transceiver receives a recommended home network trust level from a network operator server.

16. The mobile system of claim 10, wherein the processor identifies the home network base station and determines a base station trust level associated with the home network base station.

17. A home network base station for allowing access by a mobile system, comprising:
a processor that identifies the mobile system as part of a closed subscriber group and determines a mobile trust level associated with the closed subscriber group; and
a transceiver that allows access by the mobile system using an access protocol based on the mobile trust level.

18. The home network base station of claim 17, further comprising:
a data storage that stores the mobile trust level.

19. The home network base station of claim 17, further comprising:
a network interface that receives the mobile trust level from a network operator server.

20. The home network base station of claim 17, wherein the access protocol allows access to a portion of the home network based upon the mobile trust level.
